(19) United States
(12) Patent Application Publication
(10) Pub. No.: US 2008/0023932 A1
(43) Pub. Date: Jan. 31, 2008

(54) SELF PROPELLED TRICYCLE WHEEL CHAIR

(75) Inventors: Robert W. Baumbach, Sylmar, CA (US); Stuart Mackie, Whittier, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Gryphon Corporation, Sylmar, CA (US)

(21) Appl. No.: 11/828,243

(22) Filed: Jul. 25, 2007

Related U.S. Application Data
(60) Provisional application No. 60/820,928, filed on Jul. 31, 2006.

(51) Int. Cl. B62M 1/16

(52) U.S. Cl. 280/250.1

(57) ABSTRACT

The present invention relates to a portable self-propelled transport device. In some embodiments, a drive system is provided that includes a hand-pumped tiller coupled to the front wheel of a three-wheel chair. Pumping of the lever provides propulsion to the device in the forward or reverse direction as determined by how the lever is pumped. In some embodiments, the tiller is collapsible to enable the operator to approach a table while sitting in the wheel chair. In some embodiments, the chair may be collapsed for easy storage of the device.

### CROSS REFERENCE TO RELATED APPLICATIONS

This application claims the benefit of priority from U.S. provisional application No. 60/820,928, filed Jul. 31, 2006, which is incorporated herein by reference in its entirety.

### BACKGROUND

People who use manual wheel chairs are dependent upon the ability to effectively propel and steer the wheel chairs in order to maintain independence. This need extends to both the indoor and outdoor environments, each of which poses different challenges to the wheel chair design. For example, indoor spaces may be constricted and may require a wheel chair that is small, easily steered and stored. Outdoor spaces may present challenges in the form of inclines and other terrain that require a wheel chair capable of traversing the terrain with normal effort from the operator.

Accordingly, it is desirable to provide an improved manual wheel chair capable of answering these challenges.

### SUMMARY

Embodiments of the present invention provide a portable self-propelled transport device. In some embodiments, a drive system is provided that includes a hand-pumped tiller coupled to the front wheel of a three wheel chair. Pumping of the lever provides propulsion to the device in the forward or reverse direction as determined by how the lever is pumped. In some embodiments, the tiller is collapsible to enable the operator to approach a table while sitting in the wheel chair. In some embodiments, the chair may be collapsed for easy storage of the device.

According to one aspect, a self-propelled tricycle wheel chair device is provided that typically includes a tiller operatively coupled to a front wheel configured to drive the front wheel when the tiller is pumped by a user, wherein the tiller is configured to drive the device both forward and rearward. The device also typically includes handle bars coupled to the tiller configured to enable the user to steer the front wheel, and a chair disposed rearward of the tiller configured to seat the user, wherein the chair is disposed above the rear wheels and has a width substantially the same as a width of a rear axle. In certain aspects, the tiller is coupled to a connecting rod configured to rotate a drive sprocket. In certain aspects, the drive sprocket is coupled to a driven sprocket of the front axle by a chain. In certain aspects, the reduction ratio between the drive sprocket and the driven sprocket is about 4 to 3 (4:3). In certain other aspects, the reduction ratio may have a value of between about 4:3 and about 4:1.

According to another aspect, a self-propelled tricycle wheel chair device is provided that typically includes a tiller operatively coupled to a front wheel configured to drive the front wheel when the tiller is pumped by a user, wherein the tiller is configured to drive the device both forward and rearward, and wherein the tiller is collapsible about a pivot point. The device also typically includes handle bars coupled to the tiller configured to enable the user to steer the front wheel, and a chair disposed rearward of the tiller configured to seat the user, wherein the chair is disposed above the rear wheels and has a width substantially the same as a width of a rear axle. In certain aspects, the tiller is coupled to a connecting rod configured to rotate a drive sprocket. In certain aspects, the drive sprocket is coupled to a driven sprocket of the front axle by a chain. In certain aspects, the reduction ratio between the drive sprocket and the driven sprocket is about 4 to 3 (4:3). In certain other aspects, the reduction ratio may have a value of between about 4:3 and about 4:1.

According to yet another aspect, a self-propelled tricycle wheel chair device is provided that typically includes a tiller operatively coupled to a front wheel configured to drive the front wheel when the tiller is pumped by a user, wherein the tiller is configured to drive the device both forward and rearward, and wherein the tiller is collapsible about a pivot point. the device also typically includes handle bars coupled to the tiller configured to enable the user to steer the front wheel, and a chair disposed rearward of the tiller configured to seat the user, wherein the chair is disposed above the rear wheels and has a width substantially the same as a width of a rear axle, and wherein a chair back of the chair is collapsible for storage. In certain aspects, the tiller is coupled to a connecting rod configured to rotate a drive sprocket. In certain aspects, the drive sprocket is coupled to a driven sprocket of the front axle by a chain. In certain aspects, the reduction ratio between the drive sprocket and the driven sprocket is about 4 to 3 (4:3). In certain other aspects, the reduction ratio may have a value of between about 4:3 and about 4:1.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIG. 1 illustrates a front view of a self-propelled wheel chair device according to an embodiment of the present invention.

FIG. 2 illustrates a side view of a self-propelled wheel chair device according to an embodiment of the present invention.

FIG. 3 illustrates a side view of a collapsed self-propelled wheel chair device according to an embodiment of the present invention.

### DETAILED DESCRIPTION

Embodiments of the present invention provides a wheel chair device that is propelled by moving a lever or tiller fore and aft over the front wheel. The tiller is operated by hand, making the device suitable for those people who are unable to walk due to leg or other disabilities. The tiller drives the front wheel and enables the operator to move the device forward or backward. The front wheel is steered using handle bars disposed on top of the tiller. The tiller may be collapsible and the chair may be substantially similar in width as the rear wheels.

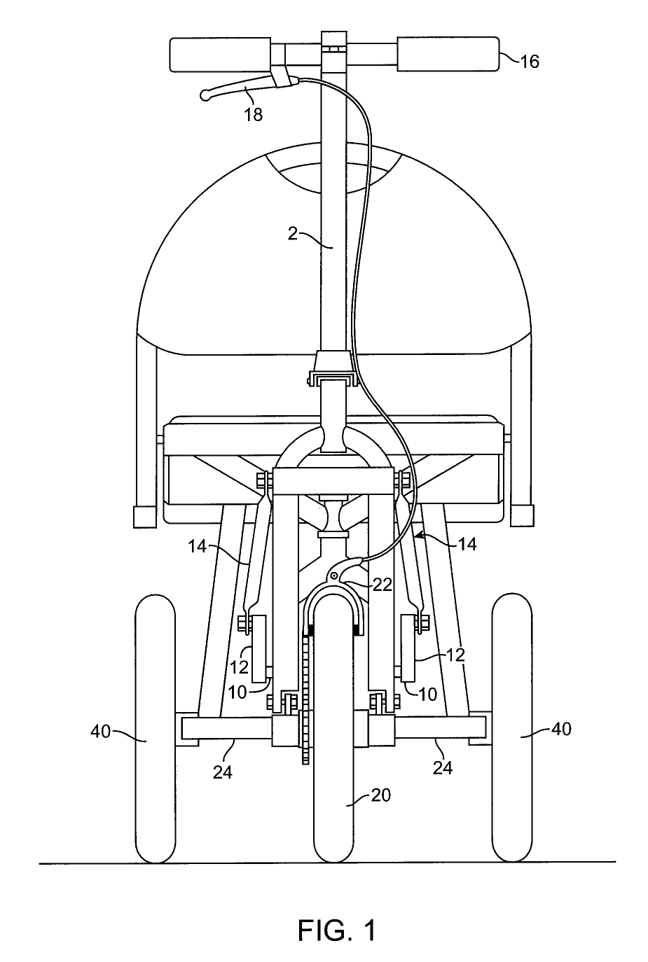

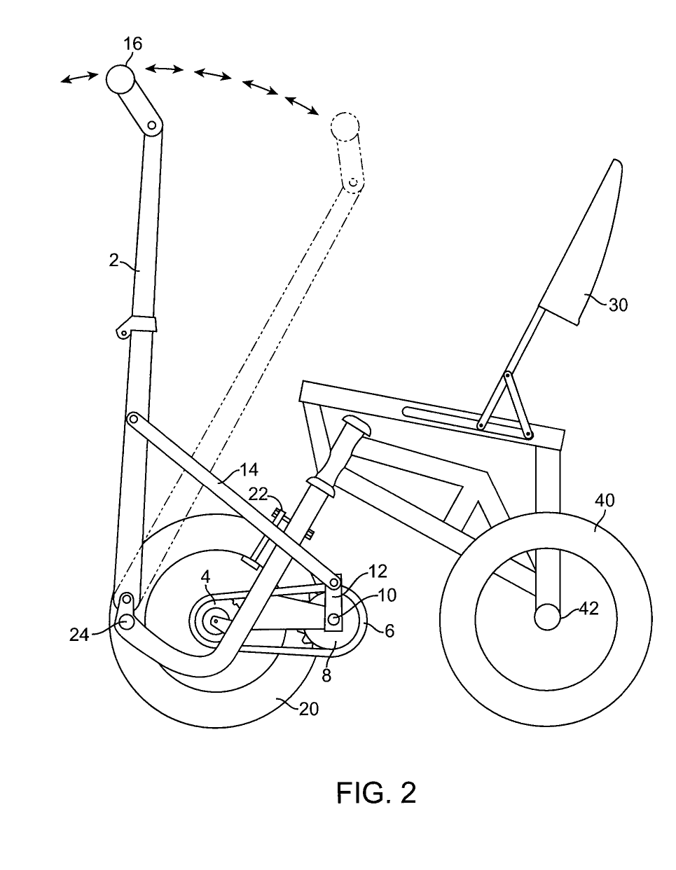

FIGS. 1 and 2 show front and side views, respectively, of a self-propelled wheel chair device according to an embodiment of the present invention. As shown, a wheelchair-like device is propelled by a drive system including a lever, or tiller 2, that is moved fore and aft to generate motion. The drive system, according to one embodiment, includes a tooth-driven sprocket 4 (e.g., an 18-tooth driven sprocket) attached to the front wheel 20, a chain 6 running from the driven sprocket 4 to the drive sprocket 8, which may be a tooth—(e.g., 24 tooth) driven sprocket 8 on a shaft 10 (e.g., a ⅝″ keyed shaft) that passes through two bushings (e.g., bronze Oilite) (not shown). One cam 12 is attached at each end of the keyed shaft 10, and two connecting rods 14 join the cams 12 to the crank arm 2. In one aspect, some or all moving parts may include ball bearings at each end.

The lever 2 is operated by hand making the device suitable for those people who are unable to walk due to leg or other disabilities. Forward or reverse motion is obtained, depending on how the lever 2 is pumped. A modest back and forth pumping of the lever 2 is sufficient to move the chair and occupant at speed equal to a brisk walk, enabling the occupant to easily keep up with friends and other pedestrians. The chair can even navigate modest inclines such as handicapped ramps.

By rotating the handle bars 16 attached to the top of lever 2, the front wheel 20 may be steered. Hand-operated brakes 18, similar to those found on a variety of bicycles, can also be mounted on the tiller 2 and connected to caliper brakes 22 on the front wheel 20. Foot rests 24 may also be provided for the comfort of the user.

The chair 30 can be made very narrow (only slightly wider than the occupant), and since the propulsion is accomplished at the front of the device, instead of by grasping the rear wheels as required by most wheel chairs, the device of the present invention can maneuver through very narrow spaces. For example, most wheel chairs cannot fit through a 2-foot wide bathroom door. However, because the occupant's hands and arms are not extended to the side of the chair (as when propelling a standard wheel chair), the device of the present invention can be propelled through a small (e.g., 19″) opening. An optional wider rear axel 42 can be interchanged with the narrow axel 42 to give the chair greater stability when the chair is used outdoors or at top speed.

In one embodiment shown in FIG. 2, the chair 30 may be substantially the same width as the width of the rear wheels 40 (i.e., width of rear axel 42). Moreover, the chair 30 may be disposed on top of the rear wheels 40 such that no part of the rear wheels is higher than the chair 30. Furthermore, the rear wheels 40 may be substantially the same diameter as the front wheel 20. In one embodiment, the chair 30 may be an off-the-shelf folding chair with the legs removed and attached to the device frame.

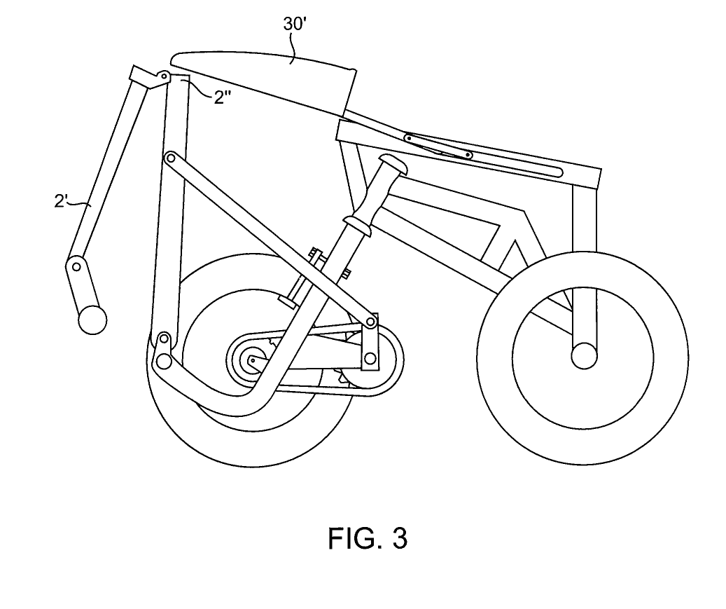

According to one embodiment shown in FIG. 3, the tiller 2 of the device is collapsible. The low stance of the device and its collapsible tiller 2 allow the occupant to use the device while sitting at a normal dining room table, a feat not easily accomplished with a standard wheel chair because of the high seat and arms. As shown in FIG. 3, a top portion 2′ of tiller 2 is folded forward at pivot point 2″, thereby enabling the front of the device to fit under a table.

Moreover, as shown in FIG. 3, the chair back 30′ may also fold forward to make the chair more compact for storage or transport. The compact size is advantageous, for example, when transporting the device in an automobile. Also, in another aspect, the entire chair 30 may be easily removed from the device, if desired, to make the device easier to store or transport, e.g., load into a car trunk.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A self-propelled tricycle wheel chair device comprising:
a tiller operatively coupled to a front wheel configured to drive the front wheel when the tiller is pumped by a user, wherein the tiller is configured to drive the device both forward and rearward;
handle bars coupled to the tiller configured to enable the user to steer the front wheel; and
a chair disposed rearward of the tiller configured to seat the user, wherein the chair is disposed above the rear wheels and has a width substantially the same as a width of a rear axle.

2. The device of claim 1, wherein the tiller is collapsible about a pivot point.

3. The device of claim 1, wherein the tiller is coupled to a connecting rod configured to rotate a drive sprocket.

4. The device of claim 3, wherein the drive sprocket is coupled to a driven sprocket of the front axle by a chain.

5. The device of claim 3, wherein the connecting rod is coupled to the drive sprocket by a cam.

6. The device of claim 4, wherein the reduction ratio between the drive sprocket and the driven sprocket is 4 to 3.

7. The device of claim 1, wherein the rear wheels have a diameter substantially the same as a diameter of the front wheel.

8. The device of claim 1, further comprising a hand brake disposed on the handle bar connected to a caliper brake on the front wheel.

9. The device of claim 1, wherein the chair is made from an off-the-shelf folding chair.

10. The device of claim 1, further comprising a foot rest disposed substantially under the tiller.

11. The device of claim 1, wherein the rear axle is configured to be exchangeable with another axle of a different width.

12. The device of claim 1, wherein a chair back of the chair is collapsible for storage.

13. A self-propelled tricycle wheel chair device comprising:
a tiller operatively coupled to a front wheel configured to drive the front wheel when the tiller is pumped by a user, wherein the tiller is configured to drive the device both forward and rearward, and wherein the tiller is collapsible about a pivot point;
handle bars coupled to the tiller configured to enable the user to steer the front wheel; and
a chair disposed rearward of the tiller configured to seat the user, wherein the chair is disposed above the rear wheels and has a width substantially the same as a width of a rear axle.

14. The device of claim 13, wherein the tiller is coupled to a connecting rod configured to rotate a drive sprocket.

15. The device of claim 14, wherein the drive sprocket is coupled to a driven sprocket of the front axle by a chain.

16. The device of claim 15, wherein the reduction ratio between the drive sprocket and the driven sprocket is 4 to 3.

17. The device of claim 13, wherein the rear wheels have a diameter substantially the same as a diameter of the front wheel.

18. The device of claim 13, further comprising a foot rest disposed substantially under the tiller.

19. The device of claim 13, wherein a chair back of the chair is collapsible for storage.

20. A self-propelled tricycle wheel chair device comprising:
a tiller operatively coupled to a front wheel configured to drive the front wheel when the tiller is pumped by a user, wherein the tiller is configured to drive the device both forward and rearward, and wherein the tiller is collapsible about a pivot point;
handle bars coupled to the tiller configured to enable the user to steer the front wheel; and
a chair disposed rearward of the tiller configured to seat the user, wherein the chair is disposed above the rear wheels and has a width substantially the same as a width of a rear axle, and wherein a chair back of the chair is collapsible for storage.
